(19) United States
(12) Patent Application Publication
(10) Pub. No.: US 2004/0142656 A1
(43) Pub. Date: Jul. 22, 2004

(54) Method and device for the broadcasting of multimedia contents to mobile terminals

(76) Inventors: Michael Bensimon, Grenoble (FR); Christophe Giraud-Sauveur, Montbonnot Saint-Martin (FR); Fabien Guinet, Pommiers La Placette (FR); Frederic Vignaud, Le Sapppey En Chartreuse (FR)

Correspondence Address: PERMAN & GREEN, 425 POST ROAD, FAIRFIELD, CT, 06824, US

(21) Appl. No.: 10/747,821

(22) Filed: Dec. 29, 2003

(30) Foreign Application Priority Data
Dec. 31, 2002 (FR) 0216931

(51) Int. Cl. H04H 7/00

(52) U.S. Cl. 455/3.06

(57) ABSTRACT

To broadcast a set of multimedia contents to mobile terminals located in a geographical zone, a broadcasting server addresses them through a short broadcast message. A geographical zone is defined as a set of cells of a mobile telephony network. The short message is received by all the mobile terminals present in these cells. The reception of this short message prompts the connection of this terminal to the broadcasting server for the retrieval of a set of multimedia contents associated with the short message. The retrieval is done in either WAP/GPRS mode or voice mode.

### BACKGROUND OF THE INVENTION.

1. Field of the Invention

An object of the invention is a method and a device for the broadcasting of multimedia contents to mobile terminals. The field of the invention is that of mobile telephony. More particularly, the field of the invention is that of the broadcasting of multimedia contents through a mobile telephony network. The term “broadcasting” is understood to mean multicast transmission, namely transmission from one server to several terminals, said transmission relating to the same contents.

It is an aim of the invention to enable the broadcasting of identical multimedia contents to several mobile multimedia terminals.

It is another aim of the invention to remove the need to know an identifier of the recipients of a broadcast in order to make this broadcast.

It is another aim of the invention to obtain a broadcasting of multimedia contents based on the geographical location of the mobile terminals that are recipients of the broadcast.

It is another aim of the invention to reduce costs related to the location of mobile terminals. 2. Brief Description of Related Developments

In the prior art, the principle of broadcasting of multimedia contents is based on the mode of addressing, whether by means of an e-mail address type of electronic address, or by a telephone number also known as the MSISDN (Mobile Station ISDN number, namely the international number of a mobile subscriber). In the prior art, it is therefore necessary to know addresses, namely public identifiers, of the recipients of the broadcast. These addresses are obtained either by a lengthy collection process in the course of canvassing to this end, or by the purchase of an address directory. Once the list of addresses has been constituted, each of these addresses can be a set of multimedia contents, and hence a broadcast can be made.

In the prior art, it is also possible to try and geographically target the broadcast on the basis of a list of addresses. To do this, it is then necessary to make a localization request for each address of the list. This localization enables a selection of the addresses corresponding to the geographical zone to be targeted. It is then possible to send a set of multimedia contents only to the addresses located in the chosen zone.

This solution used to make a geographically localized broadcast is a complex one and involves at least three distinct steps, namely: the collection of addresses, localization and, finally, the sending of messages. This approach furthermore offers very poor results in terms of geographical coverage. Indeed, there is no guarantee that the list of addresses collected comprises addresses whose carriers are located in the targeted geographical zone. Thus it is possible that the prior art solution will actually lead to non-broadcasting owing to the absence of a target in the targeted geographical zone.

In one variant of the prior art, it is possible to detect the arrival, in a geographical zone, of a terminal identified by an address. This detection can then serve to activate the sending of multimedia contents to this terminal. However, this approach is a complex one because it dictates a permanent tracking of the terminals so that their penetration into such and such a geographical zone can be detected. Here again, the performance characteristics are mediocre because they are determined by a list of addresses and conditioned by the geographical tracking of the terminals associated with this list.

Thus, the prior art approaches are firstly costly, whether in terms of the number of steps needed or in terms of their complexity. Secondly, they are low-performance approaches.

In the invention, these problems are resolved by using specific features of the mobile telephony networks. In the invention, these specific features are implemented by a server for the broadcasting of multimedia contents connected to the telephony network on which it is desired to broadcast multimedia contents. This broadcasting server is provided with at least two interfaces enabling connection thereto, and broadcasting functions. A first interface enables a broadcaster of multimedia contents to configure the broadcasting server. This configuration is done by the designation of the geographical zone, and by the supply of a set of multimedia contents to be broadcast in this zone. This association of a set of contents with a geographical zone is herein called a service that is identified by a service identifier. This service identifier enables the broadcaster to modify the configuration of the broadcasting server as far as this service is concerned. A modification is, for example, a modification of the geographical zone, a modification of the multimedia contents or an elimination of the service.

A second interface enables an apparatus that is a target of the broadcast to retrieve the multimedia contents. This retrieval can be done either through a WAP (Wireless Application Protocol) interface or through an HTTP (Hyper Text Transfer Protocol) interface, or by any interface based on TCP/IP, or by a call-back during which the multimedia contents are broadcast.

The multimedia contents are broadcast by the broadcasting server which uses SMS-CB (Short Message Service-Cell Broadcast) technology. SMS-CB is defined in phase 2 of the GSM standard and more particularly in the GSM document 03.49. The broadcasting server produces. a short broadcast message comprising a piece of information that enables the identification, on the broadcasting server, of a set of multimedia contents. The server determines the cells of the telephony network included in the targeted geographical zone. Finally the server broadcasts the message to the specified cells in using the SMS-CB technology. This has the effect wherein all the terminals connected to the specified cells receive the produced short message. At each terminal, the short message is interpreted. This prompts the retrieval of the multimedia content by the terminal.

Thus, a broadcast to all the terminals of the geographical zone is obtained.

### SUMMARY OF THE INVENTION

An object of the invention therefore is a method for the broadcasting of multimedia contents to mobile terminals wherein a server for the broadcasting of multimedia contents implements the following steps:

the storage in a contents memory of at least one set of multimedia contents,

the assigning of a service identifier to each set of stored multimedia contents,

the association with each service identifier of at least one identifier of a geographical zone,

for a set of multimedia contents, the production (307) of at least one broadcasting message, and the broadcasting of this message to the geographical zone associated with the multimedia contents, the short broadcast message comprising an identifier/address associated with the multimedia contents and the service identifier.

An object of the invention is also a device for the broadcasting of multimedia contents to mobile terminals, comprising:

means for the recording of at least one set of multimedia contents to be broadcast,

means to associate a service identifier with each set of stored multimedia contents,

means to associate at least one identifier of a geographical zone with each service identifier,

means for broadcasting short broadcast messages within a geographical zone associated with the multimedia contents, a short broadcast message comprising an identifier/address associated with the multimedia contents, and the service identifier,

means to send short broadcast messages produced.

### BRIEF DESCRIPTION OF THE DRAWINGS

The invention will be understood more clearly from the following description and the accompanying figures. These figures are given purely by way of an indication and in no way restrict the scope of invention. Of these figures:

FIG. 1 illustrates means to implement the method according to the invention;

FIG. 2 is a synthetic illustration of the method according to the invention;

FIG. 3 is an illustration of steps of the method according to the invention; and

FIG. 4 is a schematic illustration of the contents of messages exchanged during the implementation of the method according to the invention.

### DETAILED DESCRIPTION OF THE PREFERRED EMBODIMENT(S)

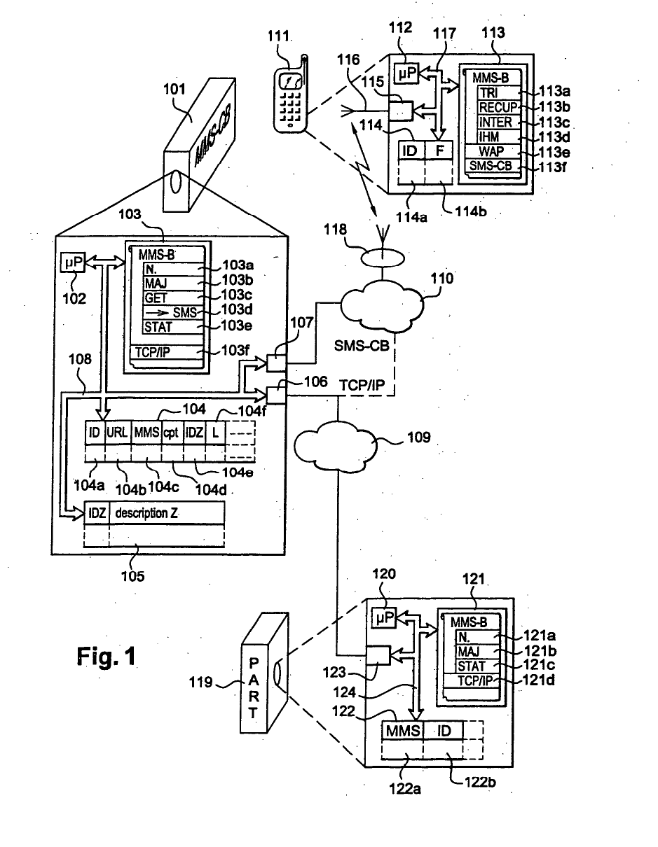

FIG. 1 shows a broadcasting server 101 comprising means to implement steps of the method according to the invention. The server 101 has a microprocessor 102, a program memory 103, a multimedia contents memory 104, a memory 105 for the description of geographical zones, interface circuits 106 for interfacing with an Internet type network 109 and interface circuits 107 for interfacing with a mobile telephony network 110. The elements 102 to 107 are connected through a bus 108. The microprocessor 102 performs actions that correspond to the execution of instruction codes recorded in the memory 103. When an action is attributed to the server 101, it is performed by the microprocessor 102. In general, when an action is attributed to an apparatus, this action is performed by a microprocessor of this apparatus controlled by instruction codes of the program memory of this apparatus.

The representation of FIG. 1 shows several memories for an apparatus. This choice has been made with a view to clarity. In practice, the information corresponding to these memories can be recorded on only one component as well as on several components.

The memory 103 is divided into several zones to illustrate the different functions of the server 101. Only the zones directly related with the invention are represented, and the memory 103 obviously comprises other zones. This is also the case for other program memories described here below.

The memory 103 comprises a zone for the management of the broadcasting of multimedia contents. A zone of a program memory comprises instruction codes for the performance of a function by microprocessor. A zone 103a corresponds to the creation of a new service/multimedia content in the memory 104. A zone 103b corresponds to the updating of a set of multimedia contents in the memory 104, an updating being a modification or elimination. The zone 103c corresponds to the processing of a request for the retrieval of multimedia contents by a mobile telephone that gets connected to the server 101. The zone 103d corresponds to the management of short broadcast messages (or SMS-CB messages), a zone 103e corresponds to the management of the connection with a server of a broadcaster of multimedia contents seeking, for example, to retrieve statistics relating to access to multimedia contents recorded in the memory 104. A zone 103f corresponds to the management of communications according to the TCP/IP (Transfer Control Protocol/Internet Protocol).

The memory 104 is structured as a table, each role corresponding to a service/multimedia contents and each column corresponding to a characteristic of the multimedia component. A column 104a enables the recording of an identifier of the multimedia contents. The contents of a slot of the column 104a are also called a service identifier. A column 104b enables the recording a public address of the multimedia contents. The column 104c enables the recording of a set of multimedia contents. A set of multimedia contents may consist of text, an image, sound, a film, an MMS (Multimedia Message Service) message, an XML voice file (XML type language for voice transmission), and/or a file in an HTML (Hypertext Markup Language) type of format. The list is not exhaustive. A column 104d is used to record a counter providing access to the multimedia contents. A column 104e is used to record an identifier of a geographical zone or zone address. A column 104f is used to record a list of customer identifiers having access to the multimedia contents. It is noted that the columns 104d and 104f correspond to statistics on the multimedia contents and are improvements of the invention. The memory 104 furthermore comprises other columns making it possible especially, for example, to record a broadcasting frequency and/or a life span for a set of multimedia contents. The memory 104 enables the recording of as many services/multimedia contents as are required by the entity implementing the server 101. In one variant, the field 104e enables the recording of a list of geographical zone identifiers.

The memory 105 enables the association of an address of a geographical zone, recorded in a column 105a, with a description of this zone. In one variant, the zone address is sufficient for a mobile telephony network to accurately route a short broadcast message. A short broadcast message is a message broadcast according to the SMS-CB referred to here above. In another variant, a description of a geographical zone is associated with a list of BSC (Base Station Controller) identifiers and/or a list of BTS (Base Transceiver Station) identifiers of the telephony network on which the broadcast is made. In the invention, a geographical zone is indeed defined by a set of BTSs. It may be recalled here that a BSC controls several BTSs. A list of BSCs therefore truly corresponds to a list of BTSs. Should a zone address be sufficient for a telephony network, the memory 105 is optional.

The circuits 107 are an interface between the signals of the telephony network 110 and the server 101. The circuits 106 are an interface between the signals of the network 109 and the server 101.

FIG. 1 shows a mobile terminal 111. In the preferred example, a mobile terminal is a mobile telephone. In certain variants, it is also a personal assistant, a palmtop, or laptop: the list is not exhaustive. The terminal 111 comprises a microprocessor 112, a program memory 113, filtering memory 114 and interface circuits 115 with an antenna 116. The elements 112 to 115 are connected to a bus 117. The antenna 116 sets up a wireless connection with a base station 118 of the network 110.

The memory 113 comprises a zone 113a corresponding to the sorting out of short messages. A zone 113b corresponds to the retrieval of a set of multimedia contents. A zone 113c correspond to the interpretation of a set of multimedia contents. A zone 113d corresponds to a man/machine interface (MMI) enabling a user of the terminal 111 to configure the contents of the memory 114. A zone 113e corresponds to the implementation of a WAP mode. A zone 113f correspond to the management of the SMS-CB messages.

The memory 114 comprises at least two columns. One column 114a records a service identifier. One column 114b specifies whether the short messages corresponding to a service have to be processed or rejected/ignored by the terminal 111. The contents of this memory zone may be edged by the user of the terminal 111 in order to modify the behavior of the terminal 111 when it filters short broadcasting messages.

In practice, the zones 113a to 113d, 113f as well as the memory 114 are an improvement of the behavior of a mobile telephone. The instruction codes of these improvements are either downloaded into the program memory 113 or pre-recorded in the memory 113, or present in the chip of a SIM-Toolkit car that is inserted into the terminal 111.

FIG. 1 also shows a server 119 of a contractual partner (hereinafter called a partner) of the telephony operator, or any other entity, managing the server 101. The server 119 has a microprocessor 120, a program memory 121, a multimedia contents memory 122 and interface circuits 123 for interfacing with the network 109. The elements 120 to 123 are connected through a bus 124.

The memory 121 has a zone 121a corresponding to the production of a new multimedia message. A zone 121b corresponds to the updating by the server 119 of a set of multimedia contents of the memory 104. A zone 121c corresponds to the retrieval of statistics on a multimedia message.

The memory 122 has at least two columns, one column 122a to record a set of multimedia contents and one column 122b to associate a service identifier with a set of multimedia contents. In one variant, the memory 122 has other columns to record broadcasting parameters for a set of multimedia contents. Such parameters are, for example, a frequency or a life span.

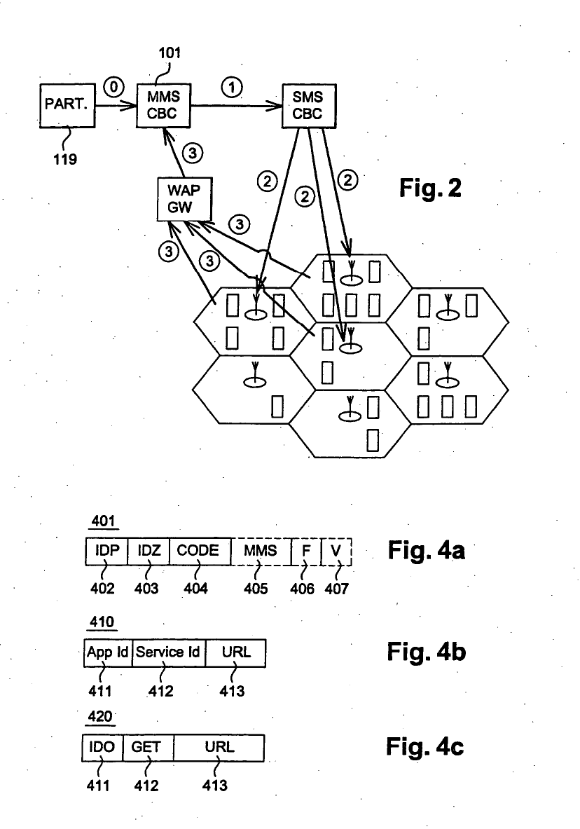

FIG. 2 shows that the server 119, in a preliminary step 0, sends the server 101 a set of multimedia contents that the entity controlling the server 119 wishes to broadcast on the telephony network of the entity controlling the server 101. The step 0 is a step for the configuration of the server 101 by the server 119, or by an apparatus equivalent to the server 119.

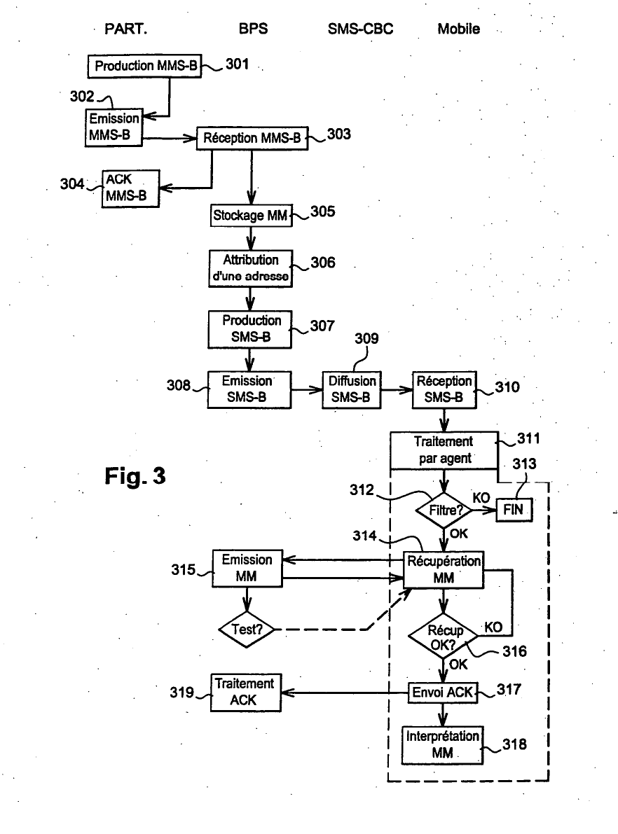

FIG. 3 shows a step 301 in which the server 119 produces a message of configuration of a broadcast of a set of the multimedia contents. The contents of such a configuration message are illustrated in FIG. 4a. FIG. 4a show that a configuration message 401 for the configuration of a multimedia broadcast comprises a field 402 for the identification of the partner sending the message 401. The message 401 also comprises an identifier 403 of a geographical zone. This is a geographical zone address. The message 401 also has an instruction code 404 used to define the end purpose of the message. The instruction code 404 is, for example, a creation code, a modification code, or code for the elimination of the multimedia service/contents. If the code 404 is a code for the updating of a set of multimedia contents, then the code 404 also has a part used to identify the multimedia contents to be updated. This part corresponds to a service identifier. Depending on the nature of the instruction code 404, the message 401 has other fields. If the message 401 is a message for the creation of a set of multimedia contents, then the message 401 has a field 405 comprising the multimedia content, a field 406 comprising a broadcast frequency for the multimedia content, and/or a field 407 comprising a life span of a multimedia message. A life span in this case is the period during which the multimedia contents must be broadcast.

In the step 301, the server 119 produces a message such as the message 401. The invention then passes to the step 302 for sending the configuration message 401 produced at the step 301. This message is sent to the server 101 for example through the TCP/IP protocol, namely through the Internet. In one variant the message 401 is enciphered. In another variant, and equivalent of the message 401 is composed online. Online composition is done, for example, through a formsheet such as the ones provided in the HTML language. In this case, as seen from the server 119, the server 101 behaves like an HTTP server. In this other variant, it is possible to implement a secured identification and/or connection. The methods by which the information corresponding to the message 401 is made to reach the server 101 are therefore numerous.

From the step 302, the invention passes to a step 303 for the reception of the configuration message 401 by the server 101. In the step 303, the server 101 updates the contents of the memory 104 as a function of the contents of the message 401, and more particularly of the instruction code 404. In any case, the server 101 ascertains that the identifier 402 is truly compatible with the operation described by the message 401. In other words, the sender of the message 401 must be authorized to carry out this operation. This verification is done, for example, by an operation for scanning an authorization memory in which the rights of the partners of the entity managing the server 101 are recorded. This authorization memory is not shown.

If the message 401 is a configuration message for the creation of a new set of multimedia contents, then the server 101 records a new line in the memory 104 corresponding to a new set of multimedia contents. The pieces of information contained in the message 401 are then transferred to this new line. The server 101 also assigns this new line a value for the column 104a and a value for the column 104b: this is an address-assigning step 306. In particular, the contents of the field 405 are transferred to the column 104c of the new line: this is the step 305. The steps 305 and 306 follow a step 303 in any unspecified order. The steps 305 and 306 are in fact sub-steps of the step 403. They are shown outside the step 303 to illustrate the fact that a set of multimedia contents is stored in the memory and that an identifier/address is associated with this set of multimedia contents. The statistics fields of this new line are set at zero or on a vacant list depending on the field considered. The server 101 then produces an acknowledgement message comprising at least the value produced for the column 104a, namely a service identifier. If it has not been possible to perform the operation of creation, then the acknowledgement message will comprise simply an error code.

In the step 306, the server 101 associates a service identifier 104a and an address 104b. In practice, it is possible to associate several addresses and hence several multimedia contents with a same identifier. This multiple association is achieved by multiplying the number of lines in the memory 104. It is thus possible that the memory 104 will comprise several lines having an identical service identifier. In this case, these lines are differentiated at least by the address field 104b. In this case, the determining of a service line in the memory 104 requires the knowledge of a service identifier, and an address. Here below, we shall consider the case where a service corresponds to only one line in the memory 104. When this is not the case, the term “service identifier” must be understood to mean a piece of information enabling a line to be determined in the memory 101. Such a piece of information is, for example, an association of the field 104a and of the field 104b.

The content of the column 104a is produced, for example, through a counter, through the intervention of an operator or through random generation, or it may be fixed by a partner, or produced by another method.

The content of the column 104b can be likened to an URL type address. For each line of the memory 104, this column has a full URL address of the type:

protocol://domain/contents.html

where protocol is a protocol (wtp, http, . . . ) used to interrogate the server 101. In this address, domain is the domain name of the server 101 on which the multimedia contents to be retrieved is recorded. Finally, contents.html is an identifier by which the multimedia contents to be retrieved can be distinguished from those of the memory 104. In one variant, only contents.html is recorded in the column 104b, the other elements of the URL being known by the apparatus that has to retrieve the multimedia content, or that is known to the server sending out messages that are currently being broadcast. Contents.html is fixed by the server 101. This fixing is achieved, for example, through a counter or action by an operator or through random generation, or it is fixed by a partner or obtained by any other method.

If the message 401 is a configuration message for the updating of a service/multimedia content, then the server 101 determines the service concerned by means of the service identifier included in the field 404. Once the corresponding line has been determined in the memory 104, the server 101 carries out the updating described in the message 401 through the instruction code 404 and its possible parameters in the following fields. This may entail replacing the content of any one of the columns 104c, 104e, or of another column used to define the way in which the multimedia contents are broadcast. Should the content of one or more columns in the line of the memory 104 be replaced, the message 401 also includes the replacement values. At the end of the operation, the server 101 produces an acknowledgement message indicating the status of the updating operation depending on whether it has been successful or not. In a preferred example, this acknowledgement message comprises the service identifier of the updated line of the memory 104. The updating may also consist in adding a set of multimedia contents to an existing service. In this case, the message 401 comprises at least one service identifier and one multimedia content.

If the message 401 is a statistics retrieval message, the server 101 determines which multimedia message it is through the service identifier included in the field 404. In response, the server 101 then produces the statistics message comprising the content of the columns of this line enabling the recording of the statistics. In the present example, these are the columns 104d, and 104f. The statistics message also includes a service identifier indicating the service to which the statistics relate. Here below, the statistics message is processed as an acknowledgement message.

In practice, a service identifier is also associated, in the memory 104, with a partner identifier. This partner identifier is not shown. This association enables the server 101 to ascertain that the actions of creation and updating have been truly performed by a partner entitled to perform these operations.

Once the processing of the configuration message 401 is completed, and the acknowledgement message has been produced, it is sent to the entity identified by the field 402 of the message 401. The method then passes to a step 304 for the management of an acknowledgement message by the server 119.

In the step 304, the server 119 is informed about the success or failure of the processing, by the server 101, of the message produced at the step 301. This enables it to update the contents of the memory 122. In particular, in the case of a configuration message for the creation of a new set of multimedia contents, the acknowledgement message comprises the service number assigned by the server 101 to this new multimedia content. This service number is then recorded in the memory 122 in correspondence with the multimedia content to which it corresponds. It is the knowledge of this service number that enables the server 119 to send messages for the configuration, updating and/or retrieval of statistics.

In FIG. 2, from the step 0, the method passes to a step 1 for the broadcasting, by the server 101 of the multimedia contents. In FIG. 3, the step 1 starts at the step 307 following the step 303, 305, or 306.

The step 307 can be activated by several events. A first event is the reception of a configuration message for the creation of a new set of multimedia contents as at the step 303. A second event is related to a regular scan of the memory 104 by the server 101. The purpose of this scan is to determine which multimedia contents must be broadcast as a function of the characteristics of the services recorded in the memory 104. The characteristics taken into account during this scan are the broadcasting frequency and the life span. A third event is the reception of a configuration message whose code 404 corresponds to an immediate broadcasting of a set of multimedia contents recorded in the memory 104.

In the step 307, once the service whose multimedia contents have to be broadcast is determined, the server 101 produces one or more SMS-CB messages, or short broadcast messages. The quantity of SMS-CB messages required for the broadcasting of the multimedia contents of the service depends on the addressing mode that exists on the telephony network on which the broadcast is made. It is already been said that, in the invention, a geographical region is a set of BSCs and/or BTSs. In one possibility, the mobile telephony network recognizes a zone identifier which, by its appellation/identification, groups together BSCs and/or BTSs. In this case, the simple fact of sending an SMS-CB message to this zone identifier is enough to ensure the broadcasting of the short message in the zone. It is also possible to send an SMS-CB message to each BSC and/or BTS units defining the zone. In this case, the zone identifier of the column 104e must be translated into a list of BSC and/or BTS identifiers. This translation is done by the server 101 through the memory 105. In both cases, the server 101 produces a short broadcast message for the geographical zone associated with the service.

A short broadcast message produced at the step 307 comprises at least the information illustrated in FIG. 4b. FIG. 4b shows a short broadcast message 410 comprising a field 411 that is an identifier of the application for which the message 410 is intended. The message 410 also has a field 412 that is an identifier of a service and an address field 413 for a multimedia content. In one variant of the invention, the message 410 does not have any field 413, the contents of the field 412 being sufficient to produce a URL (Universal Resource Locator) type address. This is quite compatible with SMS-CB technology which can be used to broadcast messages with a length that can go up to 93×15 characters.

The message 410 is inserted into the number of SMS-CB messages required to cover the zone corresponding to the service being processed by the server 101. Each SMS-CB message produces a destination address, whether it is a zone address or an address of a BSC or BTS.

From the step 307, the method passes to a step 308 in which the server 101 sends the short broadcast messages produced in the step 307. These messages are sent according to the SMS-CB technology. This broadcast corresponds to the step 2 in FIG. 2 and to the step 309 in FIG. 3. This step for the broadcasting of a short message is known, and only its main principles shall now be recalled. The messages sent at the step 308 are routed through the telephony network 110 up to the recipient apparatuses (BSC and/or BTS) of this network. These apparatuses then carry out the broadcasting of the short broadcast message to all the terminals connected to them at the time of the broadcast. In practice, the server 101 is connected to the network 110 through an SMS-CB compatible interface so that it can communicate with an SMS-CBC (SMS-CB center) of the network 110. In one variant, the server 101 communicates with the SMS-CBC server through a TCP/IP interface and therefore through an Internet type network. FIG. 2 also illustrates the fact that the geographical zone is defined by a certain number of cells of a cell telephony network. In the example of FIG. 2, the geographical zone consists of three adjoining cells. In practice, there may be any number of cells, and they may or may not be adjoining.

From the step 309, the method passes to a step 310 for the reception of an SMS-CB message by a mobile terminal. In the step 309, the mobile telephone accesses the contents of the message 410. In particular, it accesses the contents of the field 411 whose vocation is to indicate what the processing of this message 410 should be. In the present case, the field 411 indicates which is the application, on the mobile terminal 111, that is the recipient of the message 410. In this case, It Is the application capable of processing the short broadcast messages according to the invention. This application is also called an agent This agent corresponds to the instruction codes of the zones 113a to 113d.

From the step 310, the method passes to the step 311 in which the terminal implements the agent enabling the processing proper of the short broadcast message according to the invention. This processing begins at the step 312 with a filtering operation. This filtering is done by means of the contents of the field 412. The terminal 111 compares the contents of the field 412 with the contents of the column 114a. If it finds a corresponding line, i.e. if the contents of the field 412 are present in the column 114a, then the result of the filtering constitutes the contents of the column 114b. The column 114b indicates whether the processing of the message 410 must continue beyond the step 312. If the contents of the field 412 are not present in the column 114a, then a default behavior is adopted at the terminal 111. This default behavior is either an interruption of the processing, or a continuation of the processing. This is left to the discretion of the user of the terminal 111 who can configure his telephone as he wishes.

If the result of the filtering is an interruption, the method passes to the end step 313 in which the terminal returns to a state similar to the one that it would have had if it had never received the message 410.

If the result of the filtering is a continuation of the processing, the method passes to a step 314 for the retrieval of the multimedia contents associated with the service designated by the field 412 in the message 410 received at the step 310. This corresponds to a step 3 in FIG. 2. In the step 314, the terminal 111 produces a message whose contents are illustrated by the FIG. 4c. FIG. 4c shows that the request 420 for the retrieval of a set of multimedia contents comprises a field 421 that is the identifier of the sender of the request, an instruction code field 422 indicating that this is a retrieval request, and a field 423 that is an identifier of the multimedia content to be retrieved. The field 421 is also called an identifier of the origin of the request.

The content of the field 423 corresponds to the contents of the field 413. If the message 410 does not include the field 413, then the contents of the field 423 correspond to the contents of the field 412. The contents of the field 423 enable a line to be identified in the memory 104.

The retrieval can be done according to at least two modes. A first mode is a WAP/GPRS mode. In this case, the request 420 is a GET (retrieve) type request, and the content of the field 423 is a URL. In this more, the identifier 421 is an Internet address. In this mode, the contents of the field 423 constitute a URL address, or a piece of information enabling the reconstitution of a URL as described for the field of the column 104b. If the field 413 does not exist, the terminal 111 produces a URL address of the following type:

wtp://domain_server_101?serviceid=contents_field_412, or
wtp://domain_server_101?address=contents_field_412, or
wtp://domain_server_101/contents_field_412 or

This list is not exhaustive, whether with respect to the WTP protocol taken as an example or with respect to the names of the elements of the address. If the field 413 exists, either it contains a full URL that is then carried into the field 423 or it has a piece of information equivalent to a service identifier, namely a piece of information that enables the unmistakable identification of a line in the memory 104. This information then enables the production of an URL such as the one just given by way of an example. It is the GPRS/WAP mode that is illustrated in FIG. 2 which shows that the terminals of a target zone of the broadcast connect to the server 101 through a WAP gateway. In this mode, the contents of the field 423 enable the retrieval of the line of the memory 104 either through the column 104a, or through the column 104b.

A second mode is a voice mode in which the request 420 is either identical to the preceding mode or, for the field 423, has only one service identifier. In this mode, the identifier 421 is a telephone number.

Once produced, the message 420 is sent to the server 101. The method passes from a step 315 of response from the server 101 to a retrieval request 420.

In the step 315, the server 101 uses the contents of the field 423 to determine which are the multimedia contents that must be sent in response to the request 420. This is easy because either the request 420 comprises an address in the format of the address recorded in the column 104b, or the message 420 has a service identifier. It is therefore easy to determine a line of the memory 104. In the preferred variant, the contents of the field 423 can be compared to the contents of the column 104b. The contents 423 are therefore an address associated with a multimedia content by the server 101. This address enables a line of the memory 104 to be determined unmistakably. Once this line in determined, the server 101 is in possession of the multimedia contents, through the column 104c, which must be the object of the response to the retrieval request.

If the operation is in WAP/GPRS mode, the response is, for example, an MMS message, a HTML/WML file, a voiceXML file or a file in any other format compatible with the multimedia contents existing on the Internet. The server 101 then behaves like an HTTP/WTP server, or an MMS server.

If the operation is in voice mode, it means that the broadcast multimedia content consists of sound. In this mode, the server 101 uses the contents of the field 421 to call the terminal 111 in voice mode. Once the voice communication has been set up, the server 101 sends a sound signal corresponding to the multimedia contents specified by the contents of the field 412. The user of the terminal 111 is therefore called by the server 101 which behaves like an answering machine. In one variant, it is not the server 101 that calls back the terminal 111, but the terminal 111 that calls the server 101 which, here too, behaves like an answering machine.

In one variant, the server performs a test on the value of the field 421 to determine whether the user identified by this value is entitled to receive the multimedia contents.

It can be seen that, in the invention, the fact of retrieving a set of multimedia contents does not prompt the erasure of these contents from the server 101, as would be the case for a messaging server. The erasure of a service or set of multimedia contents on the server 101 is done either because the life span of the service has expired, or by the express action of the partner who has created the message. The entity managing the server 101 naturally is completely at liberty to erase a service.

From the step 315, the method passes to a step 316 in which the terminal 111 finalizing the retrieval of the multimedia contents in determining whether the retrieval of the multimedia contents has taken place properly. What is done in fact is to determine whether the message of response to the request 420 has been properly received.

In the case of the WAP/GPRS mode, the protocols implemented comprise their own frame acknowledgement mechanism by which it can be determined whether a call has truly taken place. In the case of proper communication, the terminal 111 sends a positive acknowledgement to the server 101. If not the terminal 111 either returns to the step 314 or aborts the retrieval attempt after a certain number of unsuccessful tries. In the event of failure, the terminal 111 sends a negative acknowledgement to the server 101. The sending of an acknowledgement corresponds to a step 317.

In the case of the voice mode, the simple fact that the telephone is taken up during the call from the server 101 is itself a positive acknowledgement.

From the step 317, the invention passes to a step 318 for interpreting the multimedia content. The step 318 takes place in the case of the WAP/GPRS mode. In the step 318, the terminal 111 interprets the multimedia content according to the format of this content. For this interpretation, the terminal 111 actually behaves like a WAP/HTML navigator, or an MMS interpreter.

From the step 317 the method passes also to a step 319 for the processing of the acknowledgements by the server 101. An acknowledgement message comprises the field identifying the service that it refers to, and a field indicating whether it is a positive or a negative acknowledgement. In the event of positive acknowledgement, the server 101 uses the service identifier to determine the line of the table 104 whose statistics have to be updated. This updating consists in increasing the value of the counter of the column 104d by one unit, and inserting an identifier of the customer who has sent out the request 420 in the list of the column 104f. In one variant, these updating operations are carried out upon the reception of the request 420, without waiting for an acknowledgement.

The multimedia contents broadcasting server 101 broadcasts multimedia contents on a telephony network, these contents being addressed to mobile telephony terminals. However, the teaching of the invention can be extended to other terminals, computers for example, receiving multimedia contents through at least one telephony network.

In practice, a set of multimedia contents recorded in the column 104c has a format that can be directly interpreted by a terminal getting connected to the server 101. During the configuration of the server 101 by the server 119, if the format is not right, the server 101 carries out a format conversion. Such conversions, especially conversion between the HTML and WML languages, are known in the field of mobile telephony.

With the method according to the invention, it is possible to broadcast a set of multimedia contents for several terminals sending only one short broadcast message.

With the method according to the invention, it is also possible to broadcast several sets of multimedia contents with one and the same short broadcast message. Indeed a user of a terminal can save the short broadcast message in a memory. Thus, this user can connect at will to the server 101. The partner of the entity managing the server 101 is at full liberty to modify the multimedia contents associated with said short message. In this case, it is possible that, from one connection to the next one, the user will not recover the same multimedia contents. This amounts to changing the multimedia contents associated with an address.

With the method according to the invention, it is possible to broadcast multimedia contents hosted by any server whatsoever that can be contacted through the Internet. Indeed, the fields of the column 104b may contain a URL address and may therefore address the entire Internet.

What is claimed is:

1. A method for the broadcasting of multimedia contents to mobile terminals wherein a server for the broadcasting of multimedia contents implements the following steps:
the storage in a contents memory of at least one set of multimedia contents,
the assigning of a service identifier to each set of stored multimedia contents,
the association with each service identifier of at least one identifier of a geographical zone,
for a set of multimedia contents, the production of at least one broadcasting message, and the broadcasting of this message to the geographical zone associated with the multimedia contents, the short broadcast message comprising an identifier/address associated with the multimedia contents and the service identifier.

2. A method according to claim 1, wherein the multimedia contents are obtained through a configuration message sent out by a server of a distributor of multimedia contents, the configuration message comprising at least one updating instruction code and a set of multimedia contents.

3. A method according to claim 1, wherein the association of a geographical zone and of a set of multimedia contents is updated following the reception, by the broadcasting server, of a configuration message comprising an association of a set of multimedia contents and an address of a geographical zone.

4. A method according to claim 1, wherein the broadcasting server also implements the following steps:
the reception of a request for the retrieval of a set of multimedia contents, the retrieval request comprising an identifier of the origin of the request and an identifier of multimedia contents,
the production of a response message comprising the multimedia contents,
the sending of the response message to the equipment identified by the identifier of the origin of the request.

5. A method according to claim 4, wherein the broadcasting server increments a counter associated with a set of multimedia contents for each request for the retrieval of the multimedia contents.

6. A method according to claim 4, wherein the broadcasting server updates a list of customers, said list being associated with an identifier of multimedia contents whenever a client sends out a request for retrieval of said multimedia contents.

7. A method according to claim 1, wherein a short broadcast message comprises at least one field so that the processing of the short broadcast message is assigned to an specific application on a mobile terminal that is a destination of the short broadcast message.

8. A method according to claim 1, wherein the broadcasting server also implements the following steps:
the reception of a statistics retrieval message, the retrieval message comprising an identifier of a set of multimedia contents and an identifier of the equipment from which the retrieval message originates,
the production of a response message comprising statistics associated with the identifier of the multimedia contents,
the sending of the response message to the equipment identified by the identifier of the origin of the retrieval message.

9. A method for the broadcasting of multimedia contents to mobile terminals wherein a mobile terminal implements the following steps:
the reception of a short message comprising a processing instruction code corresponding to a broadcasting of a set of multimedia contents, a service identifier and an identifier/address of a set of multimedia contents,
the determining of the relevance of a short message received as a function of the service identifier and a configuration memory of the mobile telephone,
if the message is relevant, the production, from the identifier/address of the multimedia contents, of a request for the retrieval of the multimedia contents the sending of the retrieval request and then the processing of the response to the retrieval request.

10. A method according to claim 1, wherein the response to a request for the retrieval of a set of multimedia contents is an MMS type message.

11. A method according to claim 1, wherein the response to the request for the retrieval of a set of multimedia contents is an automatic call from the terminal that has requested the multimedia contents, the multimedia contents being broadcast during this call.

12. A device for the broadcasting of multimedia contents to mobile terminals, comprising:
means for the recording of at least one set of multimedia contents to be broadcast,
means to associate a service identifier with each set of stored multimedia contents,
means to associate at least one identifier of a geographical zone with each service identifier,
means for broadcasting short broadcast messages within a geographical zone associated with the multimedia contents, a short broadcast message comprising an identifier/address associated with the multimedia contents, and the service identifier,
means to send short broadcast messages produced.
